(19) United States
(12) Patent Application Publication
(10) Pub. No.: US 2007/0050518 A1
(43) Pub. Date: Mar. 1, 2007

(54) Data transmission apparatus and recording medium storing program

(75) Inventor: Yasushi Yamade, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/271,978

(22) Filed: Nov. 14, 2005

(30) Foreign Application Priority Data
Aug. 9, 2005 (JP) 2005-230370

(51) Int. Cl. G06F 15/173

(52) U.S. Cl. 709/238

(57) ABSTRACT

A data transmission apparatus includes: a transmission unit for transmitting data; a specification unit for specifying a recipient to be a transmission destination of the data; and an address setting unit for obtaining a plurality of pieces of address information corresponding to the specified recipient from a storage unit that stores the plurality of pieces of address information of each recipient, and setting a piece of address information among the obtained plurality of address information based on time information.

### BACKGROUND OF THE INVENTION

1. Field of the Invention

The present invention relates to a data transmission apparatus transmitting data and a recording medium storing a program.

2. Description of Related Art

A transmission of data is conventionally performed using transmission means such as electronic mail and a fax. Also in a composite machine having various functions such as those of a copier, a printer and a fax, the image data read by the scanner function can be transmitted by the electronic mail or the fax. In the case where a plurality of pieces of address information of each individual is registered in a Lightweight Directory Access Protocol (LDAP) server or the like, a user selects an address from the plurality of pieces of address information, and transmits data to the selected address.

In order to automatize the selection of an address, a document transmission apparatus has been proposed (see, for example, JP-Tokukai-Hei-9-214718A). The document transmission apparatus previously stores address information of each individual, which is necessary for a transmission. The address information concerns a telephone number, a fax number, a mail ID and the like of each of a plurality of addresses such as a home, a company and the like of each individual. Then, the document transmission apparatus judges whether the document to be transmitted is a private document or whether it is a business document, and outputs the address information of either of private and business transmission destinations based on the judgment result.

Moreover, an information processing apparatus judging whether the link information indicating the place of delivery data is delivered or whether actual data is delivered based on a delivery data size has been proposed (see, for example, JP-Tokukai-2000-293448A).

However, although the above techniques have been also used, generally it is necessary for a user to judge which address more ensures an arrival to the other party in a transmission in the case where a plurality of pieces of address information of each individual is registered in the LDAP server or the like. For example, because a user must judge a place of a transmission destination or a transmission method, a user's load is large.

### SUMMARY

It is an object of the present invention to provide a data transmission apparatus capable of lightening a user's load in address setting at the time of transmitting data, and a recording medium storing a program for the sake.

To solve the above problem, in accordance with an embodiment reflecting a first aspect of the present invention, a data transmission apparatus, comprises:

a transmission unit for transmitting data;

a specification unit for specifying a recipient to be a transmission destination of the data; and

an address setting unit for obtaining a plurality of pieces of address information corresponding to the specified recipient from a storage unit that stores the plurality of pieces of address information of each recipient, and setting a piece of address information among the obtained plurality of address information based on time information.

Preferably, the transmission unit transmits the data based on the address information set by the address setting unit.

In accordance with an embodiment reflecting a second aspect of the invention, a data transmission apparatus, comprises:

a transmission unit for transmitting data;

a specification unit for specifying a recipient to be a transmission destination of the data;

a display unit; and

a control unit for obtaining a plurality of pieces of address information corresponding to the specified recipient from a storage unit that stores the plurality of pieces of address information of each recipient, and displaying the obtained plurality of pieces of address information with their priority order attached to each of them based on a transmission condition.

Preferably, the data transmission apparatus further comprises a selection unit for selecting a piece of address information among the plurality of pieces of address information displayed on the display unit together with the priority order, wherein

the transmission unit transmits the data based on the address information selected by the selection unit.

Preferably, the transmission condition includes time information.

Preferably, the transmission condition includes a data amount of the data to be transmitted.

In accordance with an embodiment reflecting a third aspect of the invention, a recording medium storing a program makes a computer realize:

a transmission function of transmitting data;

a specification function of specifying a recipient to be a transmission destination of the data; and

an address setting function of obtaining a plurality of pieces of address information corresponding to the specified recipient from a storage unit that stores the plurality of pieces of address information of each recipient, and setting a piece of address information among the obtained plurality of pieces of address information based on time information.

Preferably, the data is transmitted based on the address information set by the address setting function at a time of realizing the transmission function.

In accordance with an embodiment reflecting a fourth aspect of the invention, a recording medium storing a program makes a computer realize:

a transmission function of transmitting data;

a specification function of specifying a recipient to be a transmission destination of the data; and

a control function of obtaining a plurality of pieces of address information corresponding to the specified recipient from a storage unit that stores the plurality of pieces of address information of each recipient, and displaying the obtained plurality of pieces of address information with a priority order attached to each of them on a display unit based on a transmission condition.

Preferably, the program further makes the computer realize a selection function of selecting a piece of address information among the plurality of pieces of address information displayed on the display unit together with the priority order, and

the transmission function transmits the data based on the address information selected by the selection function at a time of realizing the transmission function.

Preferably, the transmission condition includes time information.

Preferably, the transmission condition includes a data amount of the data to be transmitted.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a block diagram showing a functional configuration of a multi function peripheral (MFP) 1 as a data transmission apparatus in an embodiment of the present invention;

FIG. 2 is a view showing the configuration of an operation unit 20;

FIG. 3 is a flowchart showing data transmission processing;

FIGS. 4A and 4B are other flowcharts showing the data transmission processing;

FIG. 5 is a further flowchart showing the data transmission processing;

FIG. 6 is a view showing an example of a display of a user authentication screen;

FIG. 7 is a view showing an example of a display of a scan setting screen;

FIG. 8 is a view showing an example of a display of an LDAP retrieval screen;

FIG. 9 is a view showing an example of a display of an LDAP retrieval result screen; and

FIG. 10 is a flowchart showing a part of the data transmission processing in a modified example.

### DETAILED DESCRIPTION OF THE PREFERRED EMBODIMENTS

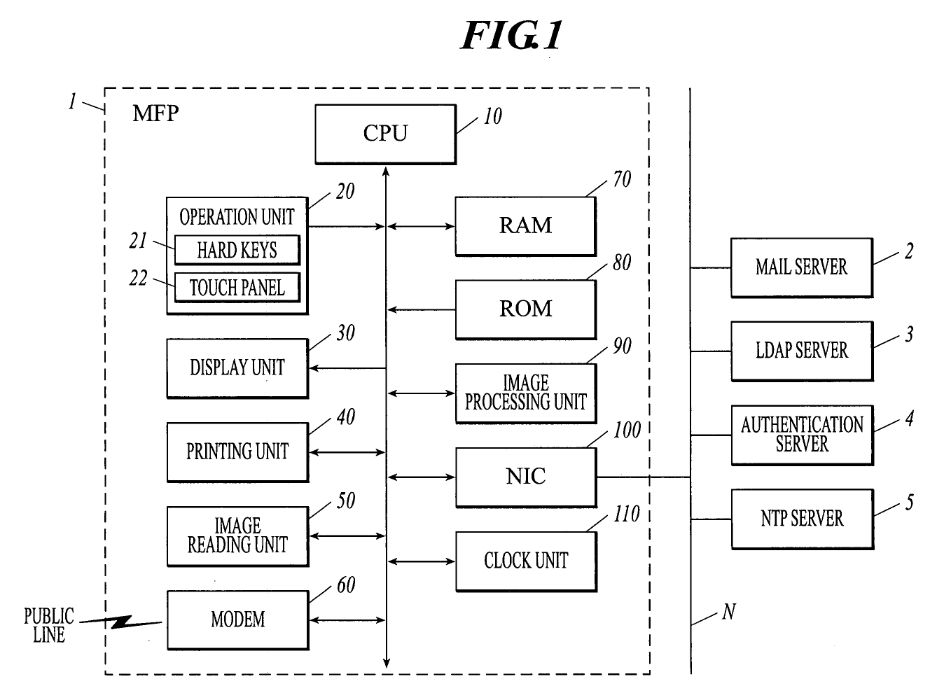

In the following, referring to FIGS. 1-9, a multi function peripheral (MFP) 1 as a data transmission apparatus according to an embodiment of the present invention is described. The MFP 1 is a composite machine including a copy function, a printer function, a scanner function, a fax function and a mail transmission function.

FIG. 1 is a block diagram showing the functional configuration of the MFP 1.

As shown in FIG. 1, the MFP 1 is equipped with a central processing unit (CPU) 10, an operation unit 20, a display unit 30, a printing unit 40, an image reading unit 50, a modem 60, a random access memory (RAM) 70, a read only memory (ROM) 80, an image processing unit 90, a network interface card (NIC) 100 and a clock unit 110. The MFP 1 is connected to a mail server 2, an LDAP server 3, an authentication server 4 and a Network Time Protocol (NTP) server 5 through a network N such as a local area network (LAN).

The CPU 10 reads a program stored in the ROM 80 according to an input instruction, and executes processing in conformity with the program. Then, the CPU 10 wholly controls the MFP 1 by performing an input and an output of an instruction and data to each functional unit.

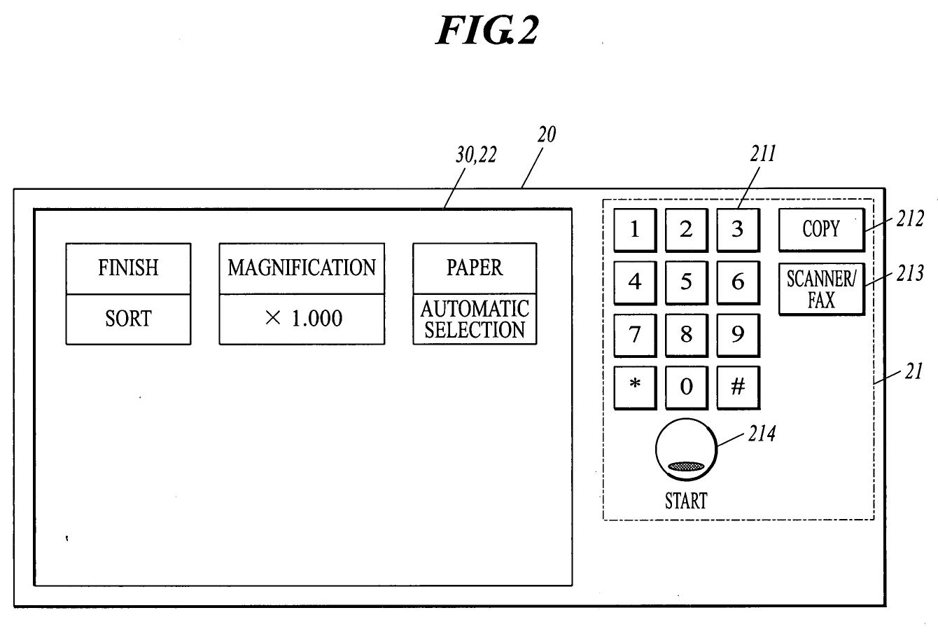

As shown in FIG. 2, the operation unit 20 is equipped with hard keys 21 such as ten keys 211, a copy mode selection key 212, a scanner/fax mode selection key 213, a start key 214 for instructing a copy, a scan and a fax transmission, and a touch panel 22 integrally formed with the display unit 30. The operation unit 20 outputs a depression signal of the depressed hard key 21 to the CPU 10. Moreover, the operation unit 20 detects a position on the touch panel 22 abutted by the tip of a finger of a user, a touch pen or the like, and outputs a positional signal to the CPU 10. When the mode of the MFP 1 is changed to a copy mode, a scanner mode or a fax mode by a depression of the copy mode selection key 212 or the scanner/fax mode selection key 213, the contents and the operation buttons which are displayed on the display unit 30 are also changed. The operation unit 20 is a unit for specifying a recipient to be the transmission destination of data. Although the recipient includes a natural person and an artificial person, a case where the recipient is a natural person is exemplified to be described in the present embodiment. Moreover, the operation unit 20 is a selection unit for selecting one piece of address information among a plurality of pieces of address information displayed on the display unit 30 with a priority order.

The display unit 30 is made of a liquid crystal display (LCD) or the like, and the touch panel 22 is superimposed on the display unit 30 to form a touch screen. The display unit 30 displays various screens based on the display data input from the CPU 10.

The printing unit 40 is a functional unit forming an image on a sheet of printing paper. The printing unit 40 is composed of a photoconductive drum, an electrification unit performing the electrification of the photoconductive drum, an exposure unit performing the exposure scanning of the photoconductive drum surface based on image data, a developing unit adhering toner to the photoconductive drum, a transfer unit transferring a toner image formed on the photoconductive drum to a printing paper, a cleaning unit removing residual toner on the photoconductive drum, and a fixing unit fixing the toner image formed on the printing paper.

The image reading unit 50 is a functional unit equipped with an auto document feeder (ADF) reading a plurality of documents automatically to read the documents as image data. In concrete terms, light is irradiated from a light source to a manuscript on contact glass, and the reflected light reflected on the document is made to enter a charge coupled device (CCD) image sensor through a mirror unit and an imaging lens. Thus, the document is read as image data.

At the time of performing the transmission or the reception of a fax, the modem 60 converts the digital data to be transmitted by the fax into a sound signal to transmit the sound signal through a public line, or converts the sound signal input through the public line into digital data. Incidentally, the modem 60 may be connected with the mail server 2 through the public line.

The RAM 70 forms a work area temporarily storing various programs executed by the CPU 10 and the data relative to the programs.

The ROM 80 is made of a nonvolatile semiconductor memory, and stores various programs, data and the like which are executed by the CPU 10.

The image processing unit 90 performs image processing to the image data read by the image reading unit 50 or the image data received from an external apparatus.

The NIC 100 is an expansion card for connecting the MFP 1 with the network N, and transmits and receives data with the mail server 2, the LDAP server 3, the authentication server 4 and the NTP server 5.

The clock unit 110 has a clock function, and accesses the NTP server 5 periodically to perform the adjustment of time automatically.

The mail server 2 is connected to the network N, and performs the reception and the delivery of electronic mail of a user in the network N. The mail server 2 has a function of transmitting the mail received through the network N to the mail address of a transmission destination, a function of storing the mail transmitted to the mail server 2 through the network N in the mail box of each user, a function of transmitting the mail stored in the mail box to each user through the network N, and the like.

The LDAP server 3 is a server storing and managing address information such as a registered name, a mail address, a fax number, and the like of each user belonging to a company or a school using the network N. The LDAP server 3 can retrieve these pieces of information based on retrieval conditions such as the registered name.

The authentication server 4 stores the user name and the password of each user using the network N in the state of associating them with each other, and performs user authentication.

The NTP server 5 has time information, and correctly adjusts the internal clock of the MFP 1 or a personal computer (PC) connected to network N. The NTP server 5 is always correcting its own time information using highly precise time information by an atomic clock, a GPS receiver or the like.

The CPU 10 of the MFP 1 obtains a plurality of pieces of address information corresponding to a specified recipient from the LDAP server 3, and displays the obtained plurality of pieces of address information on the display unit 30 in a priority order of the pieces of address information placed based on transmission conditions. The transmission conditions mean the conditions at the time of transmitting data, and include, for example, time information and the data amount of the data to be transmitted. Moreover, the CPU 10 obtains a plurality of pieces of address information corresponding to the specified recipient from the LDAP server 3, and sets one piece of address information among the obtained plurality of pieces of address information based on the time information.

Next, the operations of the MFP 1 are described.

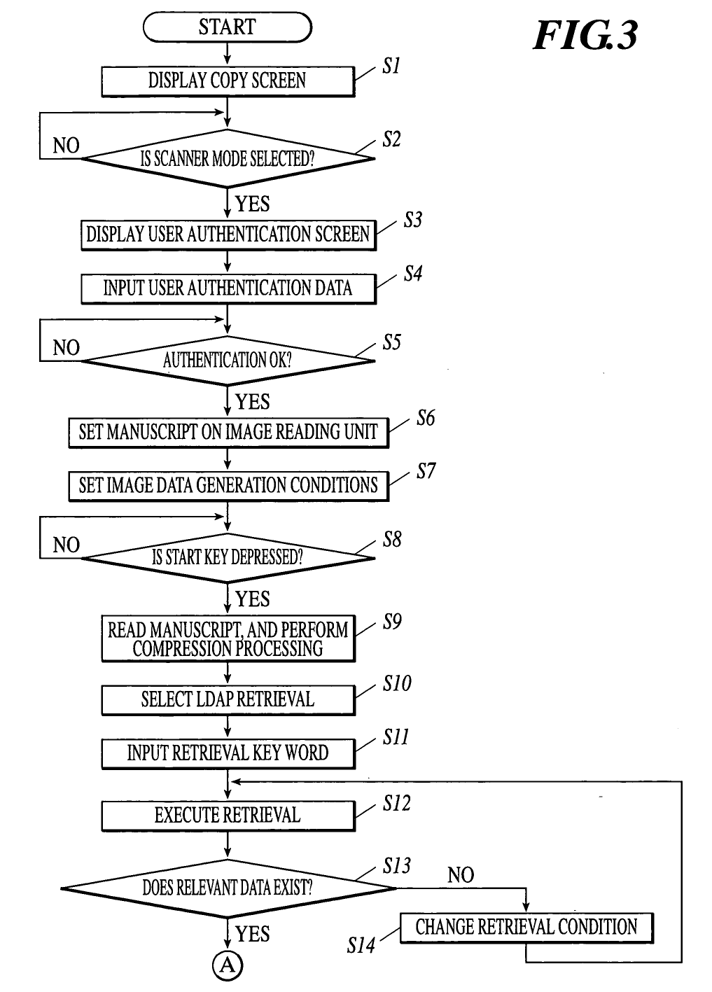

FIGS. 3, 4A, 4B and 5 are flowcharts showing data transmission processing. The data transmission processing is processing performed by CPU 10 based on a data transmission program stored in the ROM 80.

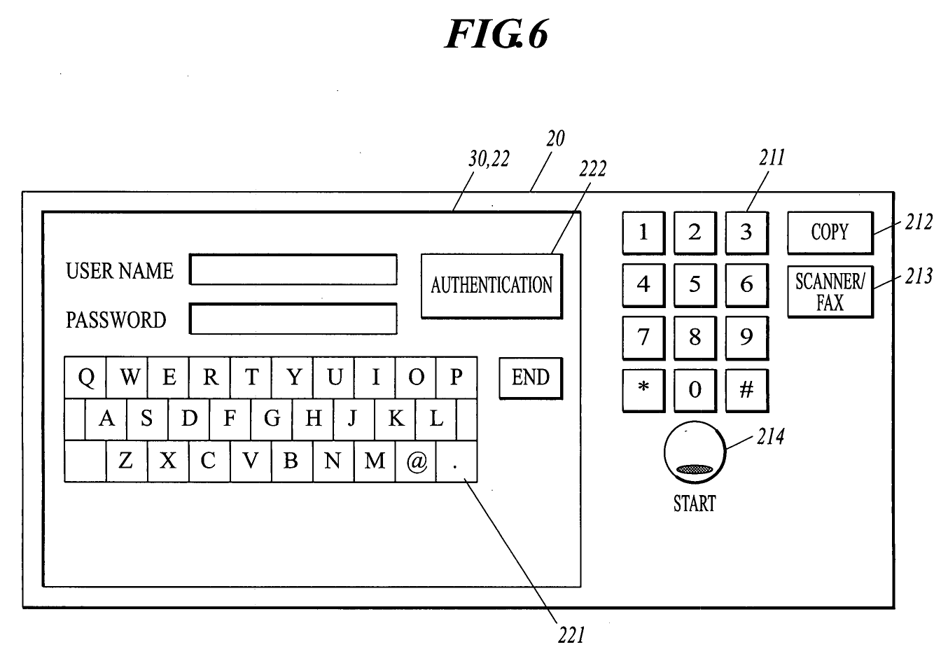

Immediately after turning on the power supply in the MFP 1, the copy screen as shown in FIG. 2 is displayed on the display unit 30 (Step S1). Here, when a user depresses the scanner/fax mode selection key 213 to select the scanner mode (Step S2; YES), a user authentication screen as shown in FIG. 6 is displayed on the display unit 30 (Step S3). Here, the user authentication is performed for the purpose of specifying the user in a circumstance where the MFP 1 is used as a network scanner, which a plurality of users can operate, and it is for preventing mischief such as sending a lot of images to a specific person.

When a user name and a password are input by the user as user authentication data from an inputting button 221 (Step S4) and an authentication button 222 is selected in the user authentication screen, an inquiry to the authentication server 4 is performed, and a judgment of whether the user in a registered user or not is performed (Step S5). When it is judged that the user is not the registered user (Step S5; NO), the processing returns to Step S4, and the input of user authentication data is performed again.

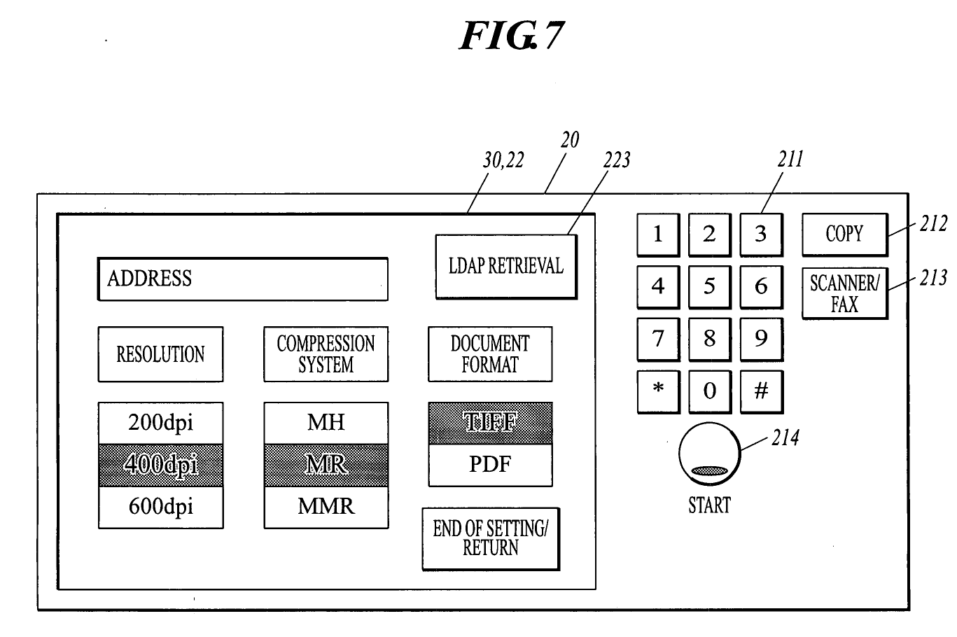

When it is judged that the user is the registered user at Step S5 (Step S5; YES), a scan setting screen shown in FIG. 7 is displayed on the display unit 30.

Next, documents are set on the image reading unit 50 (Step S6). The reading of the documents may be performed by setting the documents on the document table one by one by hand, or may be performed by reading a plurality of documents automatically by an ADF.

Next, the generation conditions of image data are set on the scan setting screen (Step S7). In the example shown in FIG. 7, a resolution, a compression system, and a document format are set as the generation conditions of the image data. The resolution is selected among 200 dots per inch (dpi), 400 dpi and 600 dpi. The compression system is selected among Modified Huffman (MH), Modified READ (MR) and Modified Modified READ (MMR). The document format is selected between Tagged Image File Format (TIFF) and Portable Document Format (PDF).

Next, when the start key 214 is depressed (Step S8; YES), a document is read by the image reading unit 50, and compression processing is performed to the read image data by the image processing unit 90 according to the generation conditions of the image data which the user set (Step S9).

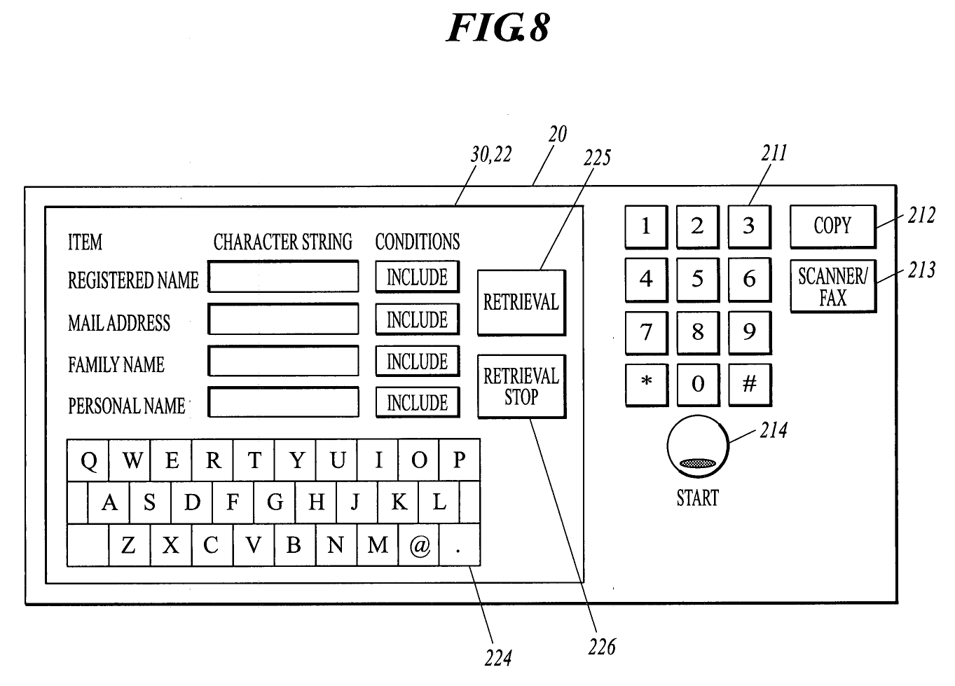

Next, when an LDAP retrieval button 223 is selected (Step S10), an LDAP retrieval screen shown in FIG. 8 is displayed on the display unit 30. When a retrieval keyword is input by the user from inputting buttons 224 (Step S11) and a retrieval button 225 is selected on the LDAP retrieval screen in order to specify a recipient who is a transmission destination of data, retrieval is executed by the LDAP server 3 (Step S12). On the LDAP retrieval screen shown in FIG. 8, retrieval can be performed using a registered name, a mail address, a family name and a personal name as the keywords. When there is no relevant data in the LDAP server 3 (Step S13; NO), the retrieval conditions are changed (Step S14), and the retrieval is executed again (Step S12). Moreover, a retrieval stop button 226 for stopping retrieval half way through the retrieval is also provided on the LDAP retrieval screen.

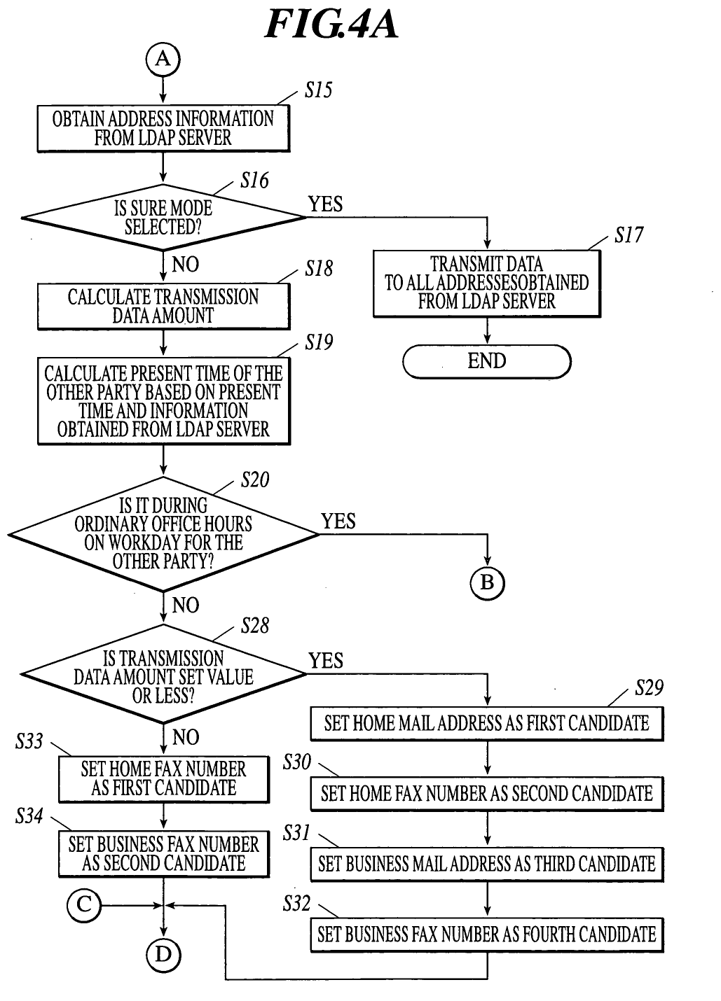

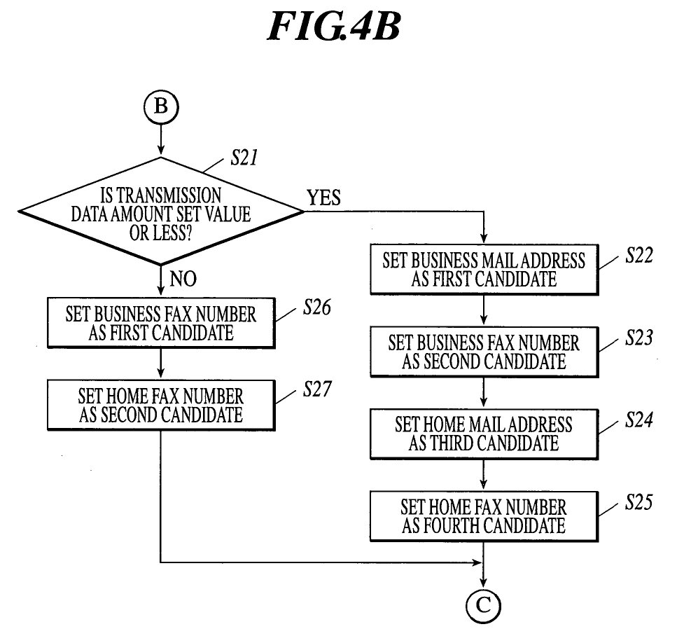

At Step S13, when there is relevant data in the LDAP server 3 (Step S13; YES), as shown in FIG. 4A, the address information of the relevant recipient is obtained from the LDAP server 3 (Step S15). The business mail address, the business fax number, the home mail address and the home fax number of the recipient are included in the address information.

Here, when a sure mode is selected (Step S16; YES), data is transmitted to all addresses based on the address information obtained from the LDAP server 3 (Step S17).

When the sure mode is not selected (Step S16; NO), the data amount of the data to be transmitted is calculated (Step S18). Moreover, the current time is read from the clock unit 110, and the current time of the other party location is calculated based on the current time and the information obtained from the LDAP server 3 (Step S19). In the case where area information (country name) is included in the information obtained from the LDAP server 3, the information is used. Moreover, it is adoptable to judge the current time of the other party location by judging the country of the other party based on the end of a mail address (for example, Japan is jp; Korea is kr; and Britain is uk), and by calculating a time difference from an area in which the MFP 1 is installed. Moreover, the current time of the other party location may be judged by judging the county and the area of the other party based on the country code and the area code of a fax number.

Next, it is judged whether the current time of the other party location is during ordinary office hours on a workday or not based on the time of the other party (Step S20). It is previously set that the ordinary office hours are, for example, from 9:00 a.m. to 5:00 p.m.

In the case where the current time of the other party side is during the ordinary office hours on a workday (Step S20; YES), it is highly considered that the recipient is at his or her office. Then, it is judged whether or not a transmission data amount is a set value or less (Step S21). Here, the set value is set as a value which a user can set, for example 1 MB, based on the restriction of the data amount which the mail server 2 can treat. The set value used as the judgment reference of the transmission data amount may be set uniformly to the mail server 2, or may be set differently every domain.

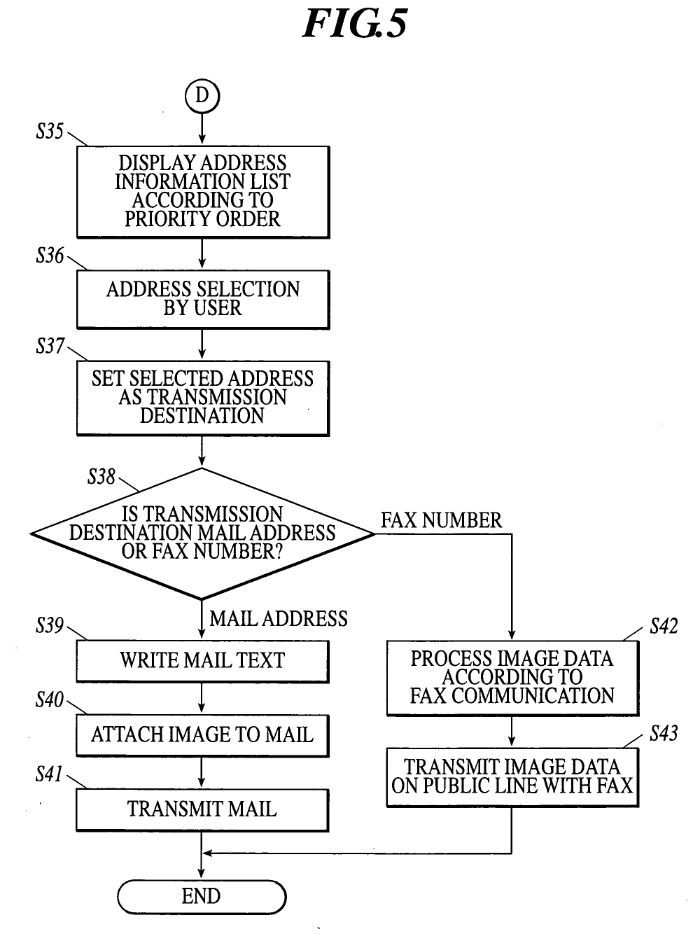

In the case where the transmission data amount is the set value or less (Step S21; YES), it is judged that mail transmission is possible. Then, the business mail address is set as a first candidate (Step S22); the business fax number is set as a second candidate (Step S23); the home mail address is set as a third candidate (Step S24); and the home fax number is set as a fourth candidate (Step S25). Then, the processing shifts to Step S35 of FIG. 5. In the case where the transmission data amount is larger than the set value at Step S21 (Step S21; NO), it is judged that any mail transmissions are impossible. Then, the business fax number is set as the first candidate (Step S26), and the home fax number is set as the second candidate (Step S27). Then, the processing shifts to Step S35 of FIG. 5.

On the other hand, in the cases where it is not a workday for the other party, or it is not an ordinary office hour (Step S20; NO), it is highly considered that the recipient is at his or her home. Then, it is judged whether or not the transmission data amount is the previously set value or less (Step S28).

In the case where the transmission data amount is the set value or less (Sep S28; YES), the home mail address is set as the first candidate (Step S29); the home fax number is set as the second candidate (Step S30); the business mail address is set as the third candidate (Step S31); and the business fax number is set as the fourth candidate (Step S32). Then, the processing shifts to Step S35 of FIG. 5. In the case where the transmission data amount is larger than the set value at Step S28 (Step S28; NO), the home fax number is set as the first candidate (Step S33), and the business fax number is set as the second candidate (Step S34). Then, the processing shifts to Step S35 of FIG. 5.

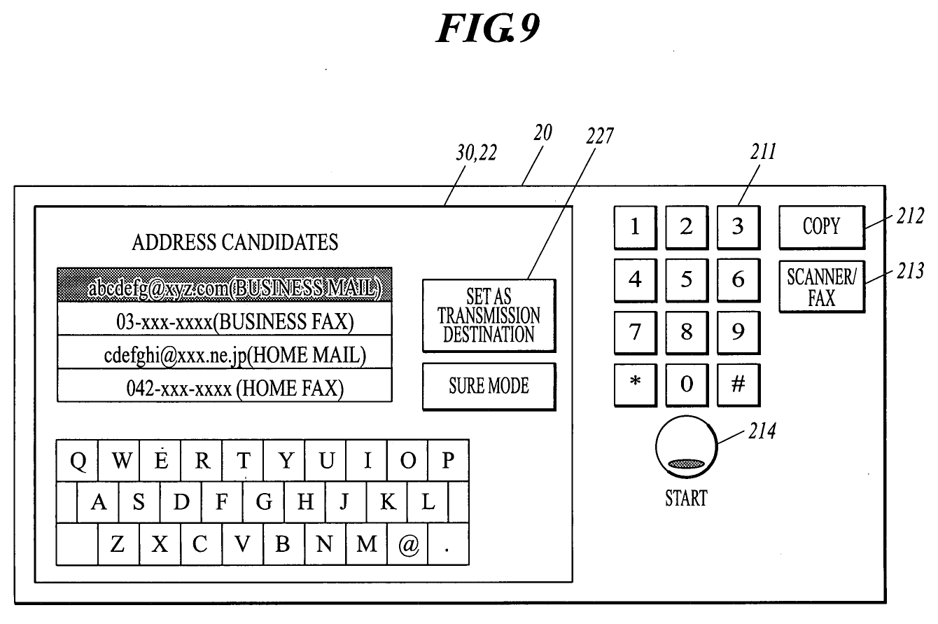

As shown in FIG. 5, after Steps S25, S27, S32 and S34, an address information list is displayed on the display unit 30 according to a priority order (Step S35). An example of the LDAP retrieval result screen is shown in FIG. 9. In the example shown in FIG. 9, the business mail address, the business fax number, the home mail address and the home fax number are set as the first, the second, the third and the fourth candidates, respectively. Then, the address information is displayed in conformity with the priority order. In FIG. 9, the business mail address of the first candidate is reversely displayed (i.e., highlighted), and the reverse display indicates the state of the selection of the business mail address. That is, the display indicates the state in which the first candidate is always selected as default.

Next, in case of the transmission to an address other than the first candidate, the address information to be set as the transmission destination is selected among the pieces of the address information displayed in conformity with the priority order by an operation of the operation unit 20 by the user (Step S36). The selected address information is reversely displayed. Incidentally, although the selected address information is reversely displayed here, the display may be performed in a manner capable of recognizing the selected address information by any manners such as a display of the selected address information with a color different from those of the other pieces of address information. Then, when a “set as transmission destination” button 227 is selected in the sate in which the address information of the previously selected first candidate or the address information selected at Step S36 is selected, the reversely displayed address information is set as the transmission destination (Step S37).

Next, when the start key 214 is depressed, it is judged whether the transmission destination is a mail address or whether it is a fax number (Step S38). In the case where the transmission destination is a mail address (Step S38; mail address), the body of the mail is prepared (Step S39); scan image data is attached to the mail (Step S40); and the mail is transmitted to the mail address through the NIC 100 (Step S41).

In the case where the transmission destination is a fax number at Step S38 (Step S38; fax number), the scan image data is processed in accordance with a fax communication (such as A4/200×200 dpi/MMR compression and the like) by the image processing unit 90 (Step S42), and the processed scan image data is transmitted by the fax on the public line through the modem 60 (Step S43).

As described above, because a priority order is placed to a plurality of pieces of address information based on time information, the priority order of the place where the possibility of finding the recipient is high can be made to be high. Moreover, because the priority order is placed to a plurality of pieces of address information based on the data amount, the priority order of the address information corresponding to the transmission method suitable for the data amount can be made to be high. In the case where the data amount which can be transmitted has a restriction such as electric mail, the mail addresses can be made to be selectable as the address information only in the case where the data amount is a set value or less. In such a manner, because a plurality of pieces of address information is displayed on the display unit 30 with the priority order placed to each of them based on the transmission condition, the load of a user in setting an address at the time of transmitting data can lightened. Moreover, data can be transmitted based on the selected address information.

Moreover, because the most suitable address information is set as the first candidate among a plurality of pieces of address information based on time information, when a user hopes the transmission to the first candidate, the user does not need to select address information, and consequently the load of the user at the address setting at the time of the transmission of data can be lightened. Moreover, data can be transmitted based on the set address information.

### MODIFICATION EXAMPLES

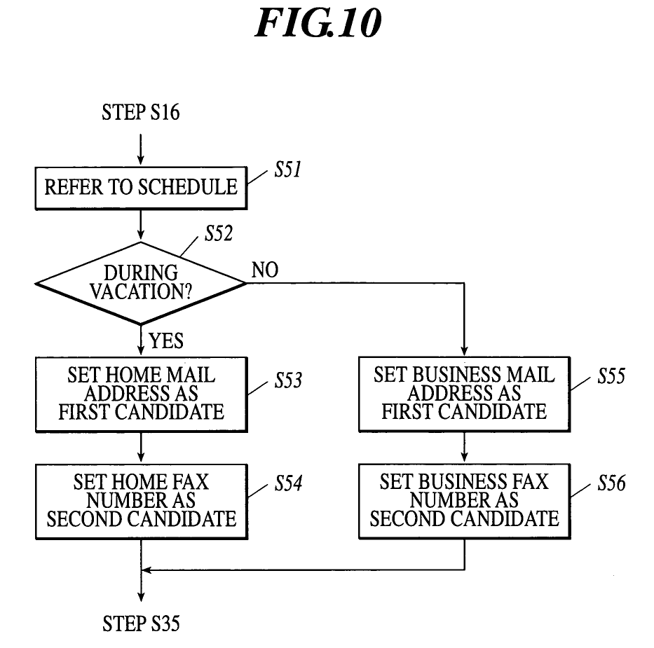

In case of using groupware such as Lotus Notes or Cybozu Office 6 (registered trademark) in an organization such as a company and a school, the recipient's whereabouts may be judged by referring to the information on each person's schedule with reference to the current time. For example, in the data transmission processing shown in FIGS. 3, 4A, 4B and 5, the processing shown in FIG. 10 may be executed in place of the processing at Steps S18-S34.

As shown in FIG. 10, a recipient's schedule is referred to based on the information on the schedule of the groupware (Step S51), and the current time is read from the clock unit 110 to judge whether the recipient is during a vacation now or not (Step S52).

In the case where the recipient is during a vacation now (Step S52; YES), it is highly considered that the recipient is at home now. Consequently, the home mail address of the recipient is set as the first candidate (Step S53), and the home fax number is set as the second candidate (Step S54).

In the case where the recipient is not during a vacation (Step S52; NO), it is highly considered that the recipient is in his or her office. Accordingly, the business mail address of the recipient is set as the first candidate (Step S55), and the business fax number of the recipient is set as the second candidate (Step S56).

In such a way, by referring to the information of the schedule of a recipient, the judgment of the place where the possibility that the recipient stays is high can be performed more accurately. In the case where it is possible to obtain more detailed address information such as a fax number of a place where the recipient has gone from the information on a schedule, the address information may be used.

The descriptions relative to the embodiment concerns an example of the implementation of the data transmission apparatus according to the present invention, and the present invention is not limited to the embodiment. The configurations of the details and the operations of the details of the data transmission apparatus can be appropriately changed in a range which does not depart from the sprit and the scope of the present invention.

For example, although the embodiment has described the case where the scan image data read with the image reading unit 50 of the MFP 1 is transmitted, the present invention can be also applied to the case where the data produced by a PC is transmitted from the PC.

Moreover, in case of a fax transmission, there is the possibility that the transmitted data is seen by a person who is not the recipient at the transmission destination. Accordingly, in case where security is given weight, the fax number may be excluded from the address information at the time of displaying the address information.

The present application is based on Japanese Patent Application No. Tokugan 2005-230370 filed with Japan Patent Office on Aug. 9, 2005.

What is claimed is:

1. A data transmission apparatus, comprising:
a transmission unit for transmitting data;
a specification unit for specifying a recipient to be a transmission destination of the data; and
an address setting unit for obtaining a plurality of pieces of address information corresponding to the specified recipient from a storage unit that stores the plurality of pieces of address information of each recipient, and setting a piece of address information among the obtained plurality of address information based on time information.

2. The data transmission apparatus of claim 1, wherein the transmission unit transmits the data based on the address information set by the address setting unit.

3. A data transmission apparatus, comprising:
a transmission unit for transmitting data;
a specification unit for specifying a recipient to be a transmission destination of the data;
a display unit; and
a control unit for obtaining a plurality of pieces of address information corresponding to the specified recipient from a storage unit that stores the plurality of pieces of address information of each recipient, and displaying the obtained plurality of pieces of address information with their priority order attached to each of them based on a transmission condition.

4. The data transmission apparatus of claim 3, further comprising a selection unit for selecting a piece of address information among the plurality of pieces of address information displayed on the display unit together with the priority order, wherein
the transmission unit transmits the data based on the address information selected by the selection unit.

5. The data transmission apparatus of claim 3, wherein the transmission condition includes time information.

6. The data transmission apparatus of claim 3, wherein
the transmission condition includes a data amount of the data to be transmitted.

7. A recording medium storing a program for making a computer realize
a transmission function of transmitting data;
a specification function of specifying a recipient to be a transmission destination of the data; and
an address setting function of obtaining a plurality of pieces of address information corresponding to the specified recipient from a storage unit that stores the plurality of pieces of address information of each recipient, and setting a piece of address information among the obtained plurality of pieces of address information based on time information.

8. The recording medium storing the program of claim 7, wherein
the data is transmitted based on the address information set by the address setting function at a time of realizing the transmission function.

9. A recording medium storing a program for making a computer realize
a transmission function of transmitting data;
a specification function of specifying a recipient to be a transmission destination of the data; and
a control function of obtaining a plurality of pieces of address information corresponding to the specified recipient from a storage unit that stores the plurality of pieces of address information of each recipient, and displaying the obtained plurality of pieces of address information with a priority order attached to each of them on a display unit based on a transmission condition.

10. The recording medium storing the program of claim 9, wherein the program further makes the computer realize a selection function of selecting a piece of address information among the plurality of pieces of address information displayed on the display unit together with the priority order, and
wherein the transmission function transmits the data based on the address information selected by the selection function at a time of realizing the transmission function.

11. The recording medium storing the program of claim 9, wherein the transmission condition includes time information.

12. The recording medium storing the program of claim 9, wherein the transmission condition includes a data amount of the data to be transmitted.
